(19) United States
(12) Patent Application Publication
(10) Pub. No.: US 2026/0026527 A1
(43) Pub. Date: Jan. 29, 2026

(54) Attractant-Palatant for Non-Carnivorous Mammals

(71) Applicants: Kurt Richardson, Maysville, GA (US); David Wilson, Jefferson, GA (US)

(72) Inventors: Kurt Richardson, Maysville, GA (US); David Wilson, Jefferson, GA (US)

(21) Appl. No.: 18/786,067

(22) Filed: Jul. 26, 2024

(51) Int. Cl. A23K 20/105; A23K 10/16; A23K 10/30; A23K 20/111; A23K 40/30

(52) U.S. Cl. CPC A23K 20/105; A23K 10/16; A23K 10/30; A23K 20/111; A23K 40/30

(57) ABSTRACT

An attractant and/or palatant composition for application of an effective amount to a particulate feed that is suitable for a non-carnivorous mammal, the composition comprising a mixture that comprises: an aroma-active component that comprises one or more volatile compounds that attract the non-carnivorous mammal, wherein each volatile compound is capable of being produced by yeast; and a coating component for securing the composition to the feed particles and facilitating a controlled release of the one or more volatile compounds from the composition, upon the composition being mixed with the particulate feed.

### BACKGROUND OF INVENTION

An attractant is defined as a substance that attracts a species of interest to increase its probability of detection. There are three basic classes of scent attractants: (1) pheromone type attractants, (2) curiosity/food attractants, and (3) food attractants.

A pheromone attractant is a chemical substance that is produced and released by an animal that affects the behavior or physiology of other animals of its species. The most well-known pheromone is castoreum which is produced by the castor glands of beavers. The use of castoreum dates back to 1797 in which fur trappers use this natural product to lure beavers to their traps. Since then, pheromone-type attractants have been developed to lure other furbearing and carnivorous mammals. Pheromone attractants do not attract non-furbearing or non-carnivorous mammals.

Curiosity/food attractants and food-scent attractants are chemical substances that a non-carnivorous mammal may recognize from their environments. Creosote bush oil, fatty acid scent, and fermented egg scent are examples of a curiosity/food attractants, whereas, apple essence, sweet corn essential oil and strawberry extract are examples of food-scent attractants. The use of curiosity/food and food-scent attractants in non-carnivorous mammals has focused on deer, feral swine, and raccoons for various purposes. In the case of deer, food-scent attractants are used to monitor density (number of deer/square mile), health, fawning rates, and buck:doe ratios. Other uses include attracting deer away from urban areas and the application of vaccines/immunosterilants.

Feral swine are considered a threat to the agriculture industry due to being a reservoir for diseases such as bovine tuberculosis, classical swine fever and African swine fever. Feral swine are also an environmental threat through damage to cultivated crops, bird nesting sites and the native ecosystem. The estimated agricultural damage caused by feral swine in the US is $200/animal/year. Feral swine may number 9 million and have been spotted in 40 states. Hunting has been the primary control method for feral swine with limited success. Trapping animals is considered a better control method, and the use of curiosity or food attractants may increase trapping efficiency. Similar to deer, attractants can be used to apply vaccines/immunosterilants.

The primary threat with raccoons is transmission of rabies to other animal species. The virus can spread to feral cats, foxes, unvaccinated dogs and even humans. Using bait containing a scent attractant has been proposed as a method for vaccinating raccoons for rabies. Scent attractants could also be used for luring raccoons away from urban areas or for trapping/relocation.

Studies on the development of attractants for non-carnivorous animals can be divided into three types: palatability or taste response studies, scent studies, and studies in which a palatant/scent is included into a bait (i.e., cereal grain, oil seed or feed). The first palatability study conducted with deer was by Dasman et al. in 1967. Dasman et al. evaluated the effect of spraying an aqueous molasses salt mixture on brush in an effort to deter deer from selective feeding on conifers. It was well known that molasses was an effective palatant when used on roughage for cattle, but its palatability in deer was unknown. Results suggested that the molasses:salt mixture increased palatability of brush to deer. No data was presented on the number of visits by deer, or the amount of treated brush consumed by deer. The Dasman et al. study pointed out a lack of taste response data in the literature for deer and other ruminants.

Crawford and Church (1971) examined the taste response of both domestic ruminants (sheep) and deer to salty, sour, sweet, and bitter tastes when added to drinking water. In pen trials, it was discovered that the taste response of sheep and deer differed with the level of compounds preferred and rejected. Deer had better response to sweet compounds, such as glucose and sucrose, than sheep and would tolerate higher concentrations of bitter compounds, such as quinine, than sheep. This indicates that palatability agents used in domestic animal livestock production may not necessarily be an effective palatant for deer or other wildlife.

In pen trials, Rice and Church (1974) examined the taste response of deer to water extracts of trees/brush and organic acids. The response to the palatant was dependent on the source of the extract, the concentration, and the sex of the deer. With organic acids, does showed no preference to acids compared to the control at low concentrations. However, at elevated levels, does rejected the level of acids that the bucks preferred. Rice and Church also suggested a correlation existed between the taste and odor of compounds as far as attractant qualities were concerned.

Hakim et al. (1996) evaluated the palatability of an apple juice (20%), apple odor (2%), glycerin (18%), salt (2) and water (60%) mixture. The sweet and salty mixture was placed in a water dispenser near the drinking water source and the number of visits to the dispensers and consumption was recorded (there were no water dispensers containing just water). Hakim et al. observed differences in number of visits between sexes (no visits by male deer), females, fawns, as well as individual deer. The palatability of the test solution to deer also varied by season.

Scent-type attractants for wildlife have been evaluated by 1) placing the attractant in vials containing wicks, 2) suspending the attractant on cotton inside of polyvinyl capsules, and 3) incorporating the attractant into a scent tab. The purpose of all three methods is to release the attractant into the environmental air. Mason et al. (1993) evaluated apple extract, acorn scent, sweet corn scent and peanut butter extract as scent attractants. Scent attractants were diluted in glycerol to achieve a 2% w/w stimulus concentration and placed in scent containers with wicks above salt or mineral blocks. Visits by deer were captured by camera. In the first trial, it was observed deer visited salt blocks more frequently when acorn scent, peanut butter scent, or apple scent was used compared to sweet corn scent (no salt block without scent container). No difference was observed when the scent containers were placed near mineral blocks. It was also reported that the attractiveness of the scent was dependent on the geographic placement (i.e., field vs bottomland). In their second trial, apple scent containers were placed above salt blocks, mineral blocks, molasses-mineral blocks, and molasses blocks. Contrary to the first trial, mineral blocks were more frequently visited than salt blocks, or molasses-mineral blocks. The molasses block had a negative effect in attracting deer. Mason et al. concluded that scent attractants were habitat specific, and their attractiveness was both seasonally and geographically specific.

Bean and Mason (1995) conducted a similar study in which liquid dispensers containing different sweeteners (apple juice, sodium cyclamate, and sodium saccharine) were paired with scent containers containing apple essence. Apple juice has a short shelf life in the field (24-48 hrs. before spoiling) and the sweeteners were evaluated as substitutes. In three separate dispensers, 2% apple essence was added to the sweetener, which was also paired with the scent containers. There were no liquid dispensers without the scent container (no control treatment). Deer visits were captured by camera and water consumption monitored. Based on the consumption data, deer preferred the taste of apple juice. Consumption increased when apple essence was added to the test solution. Bean and Mason did not provide data on number of visits, number of animals, or sex of animals.

Campbell and Long (2008a) evaluated the effectiveness of liquid domestic swine feed additives, flavorings, and a swine pheromone in attracting feral swine. The attractants—strawberry, apple, berry, caramel, Boarsman pheromone, banana, bubblegum, butterscotch, cheese, Pig frenzy, and anise—were suspended on cotton and placed in a polyvinyl capsule. A control capsule contained cotton only. Capsules were tethered to the ground and replaced daily. Wildlife activity was monitored by a camera. Only strawberry scent (ketones, aldehydes, and furanone) and apple scent (trans-2-hexenal and ethyl-2-butanoate) attracted wild swine. Raccoons also appeared to be attracted to the strawberry scent. Deer were not attracted to any of the scents.

Snow et al. (2022) evaluated the effectiveness of 60 scent attractants (both pheromone and food attractants) in scent tab form for their use in attracting feral swine. Food scents included sweet corn essential oil, peanut butter oil, orange oil, cinnamon oil, cheese oil, apple essence, strawberry extract, methyl anthranilate, watermelon flavor, garlic oil, and fatty acid scent. Attractants were replaced every three days and activity monitored by camera. Snow et al. concluded that there was little evidence that the scents tested attracted feral swine or other non-carnivores. They did report that strawberry extract and creosote increased the probability of visits in the fall only. It was concluded that location and season were important variables when evaluating attractants.

The third method by which wildlife attractants have been evaluated is by incorporation of the attractant into feed/bait, such as cereal grains, oil seeds, or pelleted feed. Many different cereal grains (i.e., corn, barley, wheat, and rye) and oil seeds (i.e., soybean, peanuts, sunflower, linseed, and rapeseed) have been used individually or in various combinations as feed/bait. However, corn is the most commonly used feed/bait due to cost and availability (Fadiac, 2019; Snow et al., 2017 and 2022). Feeds/baits are introduced to the animal through spin cast feeders, gravity flow feeders, or feeding troughs. A spin cast feeder consists of a closed top drum suspended above a bait dispensing unit. The dispensing unit has a spinning plate powered by a 6- or 12-volt electric motor that is either controlled by a photoelectric cell (dawn or dust) or programmable timer. Once activated, the spin cast feeder distributes a small volume of bait on the ground for consumption by the animal. There are several types of gravity flow feeders ranging from a simple 3-4 ft tube (4-6 inches in diameter) that animals feed from to feeders that have drums with multiple feeding ports. With gravity flow feeders, animals can consume more feed/bait in a given time interval rather than searching on the ground for a small amount of bait that is distributed by the spin cast type feeder. Gravity flow feeders and trough feeders are normally used to provide animals with nutrients (i.e., energy, protein, vitamins, and minerals) to improve animal health and growth rate.

A review of the literature did not reveal any data on using an attractant in bait for non-carnivorous mammal with the exception of feral swine. In a published review of the literature on deer attractants added to bait, Fadiac (2019) concluded, “A diverse range of attractants are available commercially and advertise efficacy, yet there are few published studies analyzing their efficacy.” In the case of swine attractants added to bait, the use of corn amended with sugar, molasses, beer, gelatin desert (e.g., JELL-O), gelatin, or live yeast to cause aerobic fermentation (souring) to attract feral swine has been spread by “word of mouth” for years with hundreds of recipes available on the internet. However, trials conducted by Wyckoff et al. (2006) and Williams et al. (2011), reported that soured or fermented corn was no more attractive than dry unfermented corn. In fact, Williams et al. stated that feral swine spent more time at dry corn sites than sour corn sites. Such fermentation of corn or feed can also have detrimental effects on wildlife due to the production of toxic compounds (i.e., mycotoxins) and harmful bacteria.

Campbell and Long (2008a) earlier observations that swine were attracted to a strawberry scent tab led them to incorporate a strawberry scent into a grain-based bait in a feral swine study (Campbell and Long 2008b). Data on visits and consumption of baits was reported for various animal species. Campbell and Long observed that the number of visits and consumption of strawberry flavored baits by swine was similar to the unscented control bait. The number of visits by raccoons to strawberry flavored baits was also similar to the unscented control, however, raccoons completely avoided consuming any of the strawberry flavored bait. In addition, the number of visits by deer and consumption of strawberry flavored baits were lower than the unscented control bait indicating that a strawberry flavored bait had a negative effect.

Snow et al. (2016) evaluated adding 20% peanut butter slurry (thickened peanut oil and peanut paste) to corn as an attractant for feral swine. No difference in the number of visits were observed for feral swine, deer, or raccoons.

Karlin and Khan (2020) were successful in attracting feral swine when adding an orange scent (d-limonene and other hydrocarbon aldehydes) to corn. Scented corn had more visits by feral swine than unscented corn. However, adding an orange scent to corn had a negative effect on the number of visits by deer and raccoons.

Typical scent-based food attractants do not take into account the familiarity of the target animal to the scent being evaluated. For example, animals may not be in an area in which apple trees grow, thus an apple scent is unnatural to them. They may be curious about the aroma, but do not associate it with a natural food source. The same occurs with other scents such as acorn scent in a region where no oak trees grow as observed by Mason et al. (1993).

A need exists for a curiosity/food and/or food-scent attractants in non-carnivorous mammals, including deer, feral swine, and raccoons, for various purposes, for which the animals are familiar regardless of the location.

### SUMMARY OF INVENTION

An embodiment of the present invention is directed to an attractant and/or palatant composition for application of an effective amount to a particulate feed that is suitable for a non-carnivorous mammal, the composition comprising a mixture that comprises:
an aroma-active component that comprises one or more volatile compounds that attract the non-carnivorous mammal, wherein each volatile compound is capable of being produced by yeast subjected to anaerobic fermentation; and
a coating component for securing the composition to the feed particles and facilitating a controlled release of the one or more volatile compounds from the composition, upon the composition being mixed with the particulate feed.

An embodiment of the present invention is directed to a method of preparing the above-described attractant and/or palatant composition, wherein the method comprises mixing the aroma-active component and the coating component.

An embodiment of the present invention is directed to a method of treating a particulate feed for a non-carnivorous mammal, the method comprising contacting the particulate feed with an effective amount of the above-described attractant and/or palatant composition such that particles of the particulate feed are at least partially coated with the attractant and/or palatant composition.

An embodiment of the present invention is directed to a treated particulate feed for a non-carnivorous mammal, the treated particulate feed comprising an effective amount of the above-described attractant and/or palatant composition at least partially coating particles of the particulate feed.

An embodiment of the present invention is directed to a method of attracting a non-carnivorous mammal to a location, the method comprising making available, dispensing, and/or dispersing the above-described treated particulate feed for a non-carnivorous mammal at the location.

An embodiment of the present invention is directed to a method of increasing a number of visits of a type of non-carnivorous mammal to a location and/or the duration of such visits during a particular period, the method comprising making available, dispensing, and/or dispersing the above-described treated particulate feed for a non-carnivorous mammal at the location, wherein said increase in number of visits and/or duration of such visits is relative to the number of visits and/or duration of visits by the type of non-carnivorous mammal to the same or comparable location over the same or comparable period while identically making available, dispensing, and/or dispersing an untreated particulate feed that is otherwise identical to the treated particulate feed but without the attractant and/or palatant composition.

### DETAILED DESCRIPTION OF INVENTION

A scent that is common in all geographical regions and is associated with a food source is the aroma of yeast. Fruits, berries, nuts, and cereal grains may undergo fermentation by yeast under normal environmental conditions. During this fermentation, yeast produce volatile compounds that have a unique aroma. It is believed that animals associate this aroma with a food source. The incorporation of yeast as an attractant into wild game feed or feed ingredients poses a challenge. Yeast is a fine granular powder and may segregate by density or particle size in a feed/grain bag during transport/handling, during the addition to the feeder or during the operation of the feeder. This would result in non-uniform distribution of the dried yeast and result in erratic results. Coating the yeast with a liquid, such as fat or a surfactant, that would adhere to the feed or feed ingredient reduces the risk of segregation and would improve distribution. Coating of the yeast would also increase its density preventing it from dissipating into the wind and diluting the aroma in the area where feeding is occurring.

In an embodiment, the present invention is directed an attractant and/or palatant composition for application of an effective amount to a particulate feed that is suitable for a non-carnivorous mammal. The composition comprises a mixture that comprises: an aroma-active component that comprises one or more volatile compounds that attract the non-carnivorous mammal, wherein each volatile compound is capable of being produced by yeast subjected to anaerobic fermentation; and a coating component for securing the composition to the feed particles and facilitating a controlled release of the one or more volatile compounds from the composition, upon the composition being mixed with the particulate feed.

In an embodiment, the one or more non-carnivorous mammals is selected from the group consisting of deer, raccoon, swine, and combinations thereof.

In an embodiment, the particulate feed comprises a cereal grain, oilseed, pelleted feed, or combinations of the thereof. In an embodiment, the cereal grain is selected from the group consisting of corn, sorghum, barley, oats, rye, millet, wheat, rice, and combinations thereof; and the oilseed is selected from the group consisting of soybean, rapeseed, canola, sunflower, peanut, and combinations thereof. In an embodiment, the cereal grain is whole, rolled, cracked, roasted, or a combination thereof; and the oilseed is whole, rolled, cracked, roasted, or a combination thereof.

### Aroma-Active Component

As indicated above, the aroma-active component comprises one or more volatile compounds that attract the non-carnivorous mammal, wherein each volatile compound is capable of being produced by yeast.

In an embodiment, the aroma-active component further comprises a dried yeast, active and/or inactivated, that contain(s) all or a portion of the one or more volatile compounds.

In an embodiment, the aroma-active component is an active dried yeast and the effective amount of the attractant and/or palatant composition is such that, when applied to the particulate feed, the active dried yeast is at an amount in a range of about 0.1% to about 3% by weight of the particulate feed. In another embodiment, the aroma-active component is an active dried yeast and the effective amount of the attractant and/or palatant composition is such that, when applied to the particulate feed, the active dried yeast is at an amount of about 1.5% by weight of the particulate feed.

In an embodiment, the yeast capable of producing the one or more volatile compounds is one or more species within the genus Saccharomyces. In another embodiment, the yeast is selected from the group consisting of Saccharomyces cerevisiae, Saccharomyces pastorianus, Saccharomyces bayanus, Saccharomyces chevalieri, Saccharomyces paradoxus, Saccharomyces eubayanus, Saccharomyces florentinus, Saccharomyces kudriavzevii, Saccharomyces boulardi, Saccharomyces var diastaticus, and combinations thereof. In another embodiment, the yeast is Saccharomyces cerevisiae.

In an embodiment, the yeast is Picha fermentans.

In another embodiment, the yeast is selected from the group consisting of Picha fermentans and yeast selected from the genus Saccharomyces. In another embodiment, said yeast selected from the genus Saccharomyces is selected from the group consisting of Saccharomyces cerevisiae, Saccharomyces pastorianus, Saccharomyces bayanus, Saccharomyces chevalieri, Saccharomyces paradoxus, Saccharomyces eubayanus, Saccharomyces florentinus, Saccharomyces kudriavzevii, Saccharomyces boulardi, Saccharomyces var diastaticus, and combinations thereof.

### Active Dried Yeast

Yeasts are single cell, eukaryotic microorganisms used in various forms in the food and animal feed industry. Viable yeast, such as Saccharomyces cerevisiae, is used in food production in the baking of bread and fermentation industry as well as in the animal industry as a probiotic due to its antimicrobial and biosorption potential. Viable yeast products are usually in a dried form produced by drying a live yeast slurry in a tunnel, fluid-bed, or rotolouver drier at low temperatures. These gentle drying processes maintain the viability of the yeast cells. Active dried yeast is sensitive to oxygen. In order to maintain its viability, active dried yeast must be vacuumed packed or stored in packing material with inert gas to ensure optimum stability.

In the animal industry, active dried yeast may be added to animal feed as a nutritional supplement. Feed can be in a mash (ground, unheated form) or pelleted form. The pelleted form of feed is preferred due to improved handling conditions and reduced feed wastage by the animal. The pelleting process uses steam (moist heat) to condition the ground feed material (mash) prior to forcing the mash through a pellet die. The temperature of moist heat can range from 170° F. to 200° F., which denatures enzyme systems and metabolic activity rendering the yeast inactive. Any aroma compounds in the active dried yeast are volatilized during the pelleting process.

### Inactivated Dried Yeast.

The second, more commonly used form of yeast used in the food and animal industry is inactivated dried yeast (yeast culture or yeast extract). Yeast extracts are the concentrates of the soluble fraction of yeast, such as Saccharomyces cerevisiae. Yeast extracts are produced by incubating the live yeast in an energy rich media (e.g., sugar, molasses) under rigorously controlled temperature and oxygen levels. After optimum growth has been obtained, the yeast is harvested from the broth and growth stopped by heat treatment. The release of the yeast contents is by cell lysis involving one of three methods: autolysis, plasmolysis, or enzymatic hydrolysis. In autolysis, the process begins with a disruption of the cell membrane caused by cell death. Cells are subjected to a pH of 5.5 at 55° C. for 48 hours. This causes the activity of the respiratory enzymes and hydrolytic enzyme to increase. The cell becomes more porous leading to the release of the intracellular compounds into the surrounding medium. Plasmolysis is considered a modified autolysis process in which a so-called accelerator such as an inorganic salt (e.g., sodium chloride) or organic solvent (e.g., toluene or ethanol) is used to accelerate the process. Hydrolysis involves the use of acid/alkaline solutions or proteolytic enzymes such as papain, zymolyase, protamex, flaourzyme, helicase, and cellulase at 55° C. for 48 hours. The temperature and time of cell lysis result in the production of a product with little or no aroma indicating that volatile aroma compounds are no longer present.

In an embodiment, the aroma-active component further comprises a lysing agent at a concentration sufficient to cause lysis in at least a portion of any active yeast present in the aroma-active component. In an embodiment, the lysing agent is selected from the group consisting of hydrochloric acid, citric acid, and combinations thereof.

### Uses of Yeast and Yeast Extracts in Food

As a food ingredient, yeast extracts/cultures are used for their nutritional value or flavoring properties. Dried yeast extract is considered a rich source of protein (35-40% free amino acids), B-vitamins, and trace elements, which makes yeast extract an excellent nutritional supplement. As food flavoring ingredients, the aroma compounds in yeast contribute to the aroma or taste of a food when added to that food. Aroma compounds present in dried yeast products include alcohols, hydrocarbons, ketones, acids, esters, furans, and heterocyclic compounds. The type and concentration of these aroma compounds is dependent on the production process of the yeast extract. The primary aroma-active compounds known to impart flavor/taste are the heterocyclic compounds such as 2-methyl-3-furanthiol, 3-methylbutanal, 3-(methylthio) propanol, benzeneacetylaldehyde, ethylpyrazine, 3-methylthiophene, 2-methylthiazole, methylpyrazine, octanal, 2,5 dimethylpyrazine, 2,6-dimethylpyrazine, 2,3 dimethylpyrazine, dimethyl trisulfide, nonanal, and trimethylpyrazine.

In the animal feed industry, inactivated dried yeast is not commonly used due to cost. Brewer's yeast, torula yeast (produced from Candida utilis), and whey yeast are only used as specialty nutritional products. Unlike the food industry, the color and aroma of inactivated dried yeast is not considered of value to the animal. In the animal feed industry, the primary yeast products used are derived from byproducts of ethanol production by the beverage and fuel ethanol industry using Saccharomyces cerevisiae. After the fermentation process to generate ethanol is complete, large quantities of various co-products are produced that contain yeast. These co-products include distillers dried solubles, dried distillers grains, distillers dried grain with solubles, condensed distillers solubles, distillers wet grains, de-oiled maize distillers dried grains with solubles, yeast for production of distiller's products and grain distillers dried yeast (Shurson, 2018). The different processes and different strains of Saccharomyces cerevisiae yeast used in the production of these co-products contribute to their nutritional value. Although these co-products are a source of protein, vitamins, and trace minerals, they are valued primarily based on their carbohydrate content and nutritional composition.

The cell wall of yeast represents 15-20% of the dry weight of the yeast and contains carbohydrates. Glucans are the primary polysaccharide component of the cell wall of Saccharomyces cerevisiae. During autolysis, 1,3-glucan and β-1,6-glucan are produced. β-glucans have been shown to absorb/bind toxins, viruses, and pathogenic bacteria, improving animal health and growth performance. The second most important component of yeast cell walls are mannooligosaccharides or mannins. Mannins are considered prebiotics that serve as a nutrient source for normal microflora in the intestinal tract of the animal improving immune function (Shurson, 2018). Despite yeast having nutritional value, there seems to be no studies evaluating the impact of yeast on palatability of feed by domestic animals.

### Aroma Esters Produced by Yeast.

In addition to the heterocyclic compounds produced by yeast as described above, yeast produces several aroma esters through intracellular and extracellular processes during fermentation. Fermentation can be aerobic, which occurs with fruits, berries, nuts, and grains in the natural environment, or anaerobically under commercial conditions. Saerens et al (2020) reported that only small amounts of esters are produced aerobically as yeast multiply. Higher levels of esters are produced under anaerobic conditions. The concentration and type of these esters present in the fermentation media can vary based on the yeast strain utilized, fermentation conditions and the substrate used in the fermentation (Saerens et al, 2006; Nykanen and Nykanenl, 1977; Yunoki et al, 2007). Regarding the substrate, in an embodiment, the yeast is/was grown on sugar/starch source selected from the group consisting of corn, sugar cane, wheat, rice, barley, sugar beets, citrus peel, and combinations thereof. In another embodiment, the yeast was grown on corn.

These esters fall into two basic types: acetate esters and ethyl esters. Ethyl acetate, isoamyl acetate, and 2-phenyl acetate are the primary acetate esters. The acetate esters are more water soluble than the ethyl esters and are found in both the fermentation supernatant (e.g., beer, wine) and the dried yeast product. Concentrations of acetate esters in dried yeast have been reported to range from 0.4 to 63.6 ppm (Saerens et al., 2010; Yoshioka et al., 1983). The carbon length of ethyl esters produced by yeast during fermentation ranges from C₂ to C₁₄ (Saerens et al., 2006). Their solubility in water and attachment to the yeast cell wall varies based on chain length. This impacts the type and concentration found in the supernatant as well as the dried yeast product. Ethyl esters with a chain length shorter than C₆ appear primarily in the supernatant. These ethyl esters are more water soluble and do not attach to the cell wall of yeast. Ethyl esters that have a chain length of C₆ or longer are less water soluble and tend to bind to the yeast cell wall (Nordstrom, 1964). Concentrations in dried yeast can range from 0.04 to 154 ppm depending on ester type and fermentation conditions (Saerens et al., 2010; Mantzouridou et al., 2015). When exposed to oxygen and dehydration, yeast cells break and release these volatile esters into the environment.

In an embodiment of the present invention, each volatile compound is an ester that that is selected from the group consisting of acetate ester and ethyl ester. In an embodiment, the acetate ester is selected from the group consisting of ethyl acetate, isoamyl acetate, and 2-phenyl acetate; and the ethyl ester is selected from the group consisting of C₂-C₁₄ esters. In a further embodiment, the ethyl ester is selected from the group consisting of ethyl hexanoate, ethyl octanoate, and ethyl decanoate.

As noted above, the attractant and/or palatant composition is to be applied at an effective amount to a particulate feed that is suitable for a non-carnivorous mammal. In an embodiment, the effective amount of the attractant and/or palatant composition is such that, when applied to the particulate feed, each volatile compound is at an amount in a range of about 0.1 ppm to about 6 ppm by weight of the particulate feed. In another embodiment, the effective amount of the attractant and/or palatant composition is such that, when applied to the particulate feed, each volatile compound is at an amount of in a range of about 0.5 ppm to about 1 ppm. In yet another embodiment, the effective amount of the attractant and/or palatant composition is such that, when applied to the particulate feed, each volatile compound is at an amount of about 0.7 ppm by weight of the particulate feed.

In one embodiment, the present invention is directed an attractant and/or palatant composition for application of an effective amount to a particulate feed that is suitable for a non-carnivorous mammal. The composition comprises a mixture that comprises: an aroma-active component that comprises one or more volatile compounds that attract the non-carnivorous mammal, wherein each volatile compound is capable of being produced by yeast; and a coating component for securing the composition to the feed particles and facilitating a controlled release of the one or more volatile compounds from the composition, upon the composition being mixed with the particulate feed.

### Coating Component

In addition to the aroma-active component, the attractant and/or palatant composition comprises a coating component for securing the composition to the feed particles and facilitating a controlled release of the one or more volatile compounds from the composition, upon the composition being mixed with the particulate feed.

In an embodiment, the coating component is selected from the group consisting of a fat, C₆-C₂₁ fatty acid, polysorbate, ethoxylated castor oil, and combinations thereof. In an embodiment, the coating component is selected from the group consisting of one or more plant-based oils, one or more hydrogenated plant-based oils, C₈ fatty acid (caprylic acid or octanoic acid), C₁₄ fatty acid (myristic acid), polysorbate-60, polysorbate-80, ethoxylated castor oil-40 (CO-40), and combinations thereof.

In an embodiment, the effective amount of the attractant and/or palatant composition is such that, when applied to the particulate feed, the coating component is at an amount in a range of about 0.1% to about 3% by weight of the particulate feed. In another embodiment, the effective amount of the attractant and/or palatant composition is such that, when applied to the particulate feed, the coating component is at an amount of about 1.5% by weight of the particulate feed.

Method of Preparing the Attractant and/or Palatant Composition

An embodiment of the present invention is directed to a method of preparing any of the above-described embodiments of the attractant and/or palatant composition. The method comprises mixing the aroma-active component and the coating component.

### Method of Treating a Particulate Feed for a Non-Carnivorous Mammal

An embodiment of the present invention is directed to a method of treating a particulate feed for a non-carnivorous mammal. The method comprising contacting the particulate feed with an effective amount of any of the above-described embodiments of the attractant and/or palatant composition such that particles of the particulate feed are at least partially coated with the attractant and/or palatant composition.

It is believed that this method improves the attractancy and/or palatancy of the treated particulate feed to the non-carnivorous mammal relative to: (a) an identical particulate feed without the attractant and/or palatant composition mixed therewith; and/or (b) an identical particulate feed mixed with an identical amount of the identical aroma-active component without the coating component.

### Treated Particulate Feed for a Non-Carnivorous Mammal.

An embodiment of the present invention is directed to a treated particulate feed a non-carnivorous mammal. The treated particulate feed comprises an effective amount of any of the above-described embodiments of the attractant and/or palatant composition at least partially coating particles of the particulate feed.

### Method of Attracting a Non-Carnivorous Mammal to a Location

An embodiment of the present invention is directed to a method of attracting a non-carnivorous mammal to a location. The method comprises making available, dispensing, and/or dispersing the treated particulate feed for a non-carnivorous mammal at the location, wherein the treated particulate feed comprises an effective amount of any of the above-described embodiments of the attractant and/or palatant composition at least partially coating particles of the particulate feed.

Method of Increasing the Number of Visits of a Type of Non-Carnivorous Mammal to a Location and/or the Duration of Such Visits During a Particular Period

An embodiment of the present invention is directed to a method of increasing a number of visits of a type of non-carnivorous mammal to a location and/or the duration of such visits during a particular period. The method comprises making available, dispensing, and/or dispersing an above-described treated particulate feed for the type of non-carnivorous mammal at the location, wherein said increase in number of visits and/or duration of such visits is relative to the number of visits and/or duration of visits by the type of non-carnivorous mammal to the same or comparable location over the same or comparable period while identically making available, dispensing, and/or dispersing an untreated particulate feed that is otherwise identical to the treated particulate feed but without the attractant and/or palatant composition.

### EXAMPLES

### Attractant Trials

### Geographic Locations and Operation of Feeders

Attractant trials were conducted at three different geographic locations in Georgia, USA over the course of 18 months. Fadiac (2019) disclosed that variability in an attractant trial could be reduced by considering seasonality which was addressed by the length of these studies conducted during all four seasons. Any variability in the attractant trials due to geography (i.e field, lowlands, hardwoods) as reported by Mason et al. (1993) was addressed by selecting three sites with different geographic conditions.

Location 1 was a 53.5-acre plot consisting of open fields (30%) and woodlands (70%). On two sides, it was bordered by a thicketed floodplain. The other sides of the property were bordered by a pine forest and hardwoods. There were no bedding areas for deer. Deer (Odocoileus virginianus) transited the property moving from the pine forest to the thicketed floodplain (bedding areas). Erfan (2019) also disclosed that proper geographical placement of the feeders within a geographic location reduces variability in attractant trials, and this was considered in placement of the feeders. Two dispensing type feeders (30-gallon Wildgame Innovation Tripod Deer Feeder) were placed in a hardwood bottom adjacent to the pine forest and two dispensing type feeders (30-gallon Wildgame Innovation Tripod Deer Feeder) were placed in hardwoods adjacent to the thicketed floodplain for a total of 4 feeders at location 1. Paired feeders were placed approximately 200 m apart.

Location 2 was approximately 15 miles from location 1. Location 2 was a 237-acre plot consisting of farmland (70%) and woodland (30%). The property was bordered by similar type properties on three sides and a road on the fourth side. Two dispensing type feeders (30-gallon Game Winner tripod deer feeders) were placed in three different geographic locations within this site. Two were placed ˜25 m in mixed hardwoods on the edge of farmland adjacent to a stream (northeast corner), two were placed ˜25 m the mixed hardwoods on the edge of the farmland adjacent to mature pines (southeast corner) and two were placed ˜25 m inside the mixed hardwoods adjacent to a hardwood forest (northwest corner) for a total of 6 feeders at location 2. Feeders (paired) were ˜200 m apart.

Location 3 was selected because it was reported to have a feral swine issue. Location 3 was approximately 10 miles from location 1 and 15 miles from location 2. Location 3 was a 272-acre plot consisting of pasture, woods lands and heavily brushed lowlands. The property was bordered by a road on one side, an industrial park on another side and heavily brushed lowlands on the remaining two sides. Feeders (4 total; 30-gallon Game Winner molded barrel feeder) were placed on the edge of the pasture adjacent to a creek separating the pasture from the lowland. Feeders were mounted to 9 feet tall posts to prevent damage by feral swine and ˜200 m apart.

In the dispensing type of feeder, grain/feed is stored in a small drum silo with a conical bottom that sits above a spinning plate connected to a motor in the control box. The motor was controlled by a 6V digital timer. At timed intervals, the motor that rotates the spinning plate is activated spreading grain/oilseed/feed out on the ground in a cylindrical pattern. Only whole grains, oilseeds, pelleted feed, or mixtures thereof can be used in this device due to the design. Feed (˜1.5 lb./time interval) was dispensed at 4 am and 3 pm, which are times with the least amount of deer movement. The 6V battery was replaced monthly to eliminate any variability with the amount distributed over two 2-week trial periods. All visits to the feeders were conducted in clean clothes and rubber boots to minimize human scent.

Wildlife activity at the feeders was captured using Wildgame trail cameras (Wildgame Innovations Terra Model #TR8i34w7) at location 1 and Moultrie game cameras (Moultrie AC-450) at location 2 and location 3. Cameras had infrared sensors and were capable of both day and nighttime pictures. The camera was placed 7-8 m from the feeder and had unobstructed view of the feeder. The camera was activated 30 sec after movement was detected in the area of the feeder. Image of wildlife was captured on an SD card which was viewed on a computer.

A variety of wildlife was observed visiting the feeders at location 1 and 2 including deer, squirrels, raccoons, rabbits, opossums, bobcats, armadillos, coyotes, skunks, groundhogs, turkeys, and other wild birds (no feral swine were not present at locations 1 and location 2 the nearby areas). Only deer, squirrels, raccoons, and rabbits visited the feeders on a consistent basis. Turkeys, wild birds, and other wildlife did not visit on a consistent basis, which indicate they were not attracted by the products being evaluated. At location 3, the presence of feral swine appeared to limit the animals observed visiting the feeders to feral swine, deer, raccoons, opossum, and coyotes. Only feral swine visited the feeders on a consistent basis.

### Example 1—Impact of Coating of Dried Yeast when Added to Corn on Attracting Deer

Purpose—The purpose of these trials is to determine if coating active dried yeast in fat will increase the attraction of deer to corn compared to uncoated active dry yeast.

Experimental design—There were two experimental treatments, corn with 1.5% dried yeast and corn containing dried yeast coated in fat (equivalent to 1.5% dried yeast inclusion). To produce the coated yeast treatment, fat (Great Value all vegetable shortening containing no emulsifiers) was melted in a microwave and allowed to cool to ˜38° C. Fat (475 ml) was mixed with dried yeast (340 g; yeast grown on dried distillers grain) in mixing bowl and gradually added to 50 lb. corn while mixing (ProForce/2 HP portable cement mixer). For the non-coated treatment, 340 g of dried yeast was added to 50 lb. corn while mixing. The mixing time was 10 minutes for both treatments. All weighing, mixing, and handling was done with rubber gloves to minimize human scent.

Locations—Attractant trials were conducted at location 1 and 2. At location 1, there were two trials conducted in paired feeders. Each trial at location 1 had 2 replicates/treatment of the uncoated and coated yeast treatment per trial. In the second trial, the positions of the treatments were reversed to eliminate any geographic location effect. At location 2, similar studies were conducted with 3 replicates/treatment. The source of yeast used in these studies was yeast grown on dried distillers' grains.

Feeders were programmed to dispensed twice daily for 3 seconds (˜1.5 lb./dispensing). Over a course of two weeks, deer activity was recorded on SD cards using wild game cameras. The number of visits/day, number of does/fawns and number of bucks was determined. A visit constituted a 15-minute period in which no deer activity was recorded.

Results—The number of visits and number of deer during the 14-day trial period were averaged for each treatment (10 replicates/treatment). The average percent improvement due to the coating of the yeast with fat was calculated. Results are presented in Table 1.

TABLE 1
Improvement of coated yeast compared to uncoated yeast
when added to corn on the attraction of deer to feeders

| | Number/treatment (average) | | |
|---|---|---|---|
| | Uncoated | | % Improvement |
| Parameter | Yeast | Coated yeast | (average) |
| Visits | 25.6 | 106.3 | 314.6 |
| Does/fawns | 35.1 | 132.3 | 276.5 |
| Bucks | 6.8 | 19.1 | 182.7 |
| Total deer | 41.9 | 151.3 | 261.4 |

Conclusions—The pericarp of corn kernels does not allow penetration of solids/liquids. Mixing the yeast with fat produced a slurry that attached to indentations and cracks on the seed. Distribution appeared uniform among kernels. No fat coated particles were found in the bottom of the mixer. No attachment to the corn was observed with the uncoated product.

The addition of dried yeast coated with fat to corn was more effective in attracting deer to the feeders than when uncoated dried yeast was added to corn. This was demonstrated by the increased number of visits and increased number of deer visiting the feeders. This effect was not related to the geographic location of the feeders due to the design of the trials (i.e., reversing treatment location in the two trials at location 1 and location 2). The increase in the attractive qualities of fat coated yeast compared to uncoated yeast was equally observed with both sexes which has not previously been reported in the literature (Hakim et al, 1996). In trials conducted with potential attractants added to water or in a capsule form, male deer did not respond to the attractant.

### Example 2—Impact of Coating of Dried Yeast when Added to Corn, Oilseeds, or Pelleted Feed on Attracting Deer

Purpose—The purpose of this trial is to determine if coating active dried yeast in fat will increase the attraction of deer to cereal grains, oilseeds or pelleted feed compared to active dry yeast.

Experimental design—There were two experimental treatments per trial, 1) feed matrix containing fat coated yeast and 2) feed matrix containing uncoated yeast. Feed matrices used in the trials included whole grain deer feed (43:43:14 ratio of corn:roasted soybean:peanuts), roasted soybeans or pelleted deer feed (17% protein). Treatments were prepared as described in Example 1.

Attractant trials were conducted at location 1. There were two trials conducted with each bait matrix in paired feeders. Each trial had two replicates/treatment of the uncoated and coated yeast product per trial. In the second trial, the positions of the treatments were reversed to eliminate any geographic

Results—The number of visits and number of deer for the 14-day trial period were averaged for each treatment (4 replicates/treatment). The average percent improvement due to the coating of the yeast was calculated. Results are presented in the following tables.

TABLE 2
Improvement of coated yeast compared to uncoated yeast when added
to whole grain deer feed on the attraction of deer to feeders¹

| | Number/treatment (average) | | % Improvement |
|---|---|---|---|
| Parameter | Uncoated Yeast | Coated yeast | (average) |
| Visits | 89 | 123 | 38.2 |
| Does/fawns | 100 | 137 | 37.0 |
| Bucks | 9 | 17 | 88.9 |
| Total deer | 109 | 154 | 41.3 |

¹Trial conducted with yeast grown on dried distillers grain.

TABLE 3
Improvement of coated yeast compared to uncoated yeast when added
to roasted soybeans on the attraction of deer to feeders¹

| | Number/treatment (average) | | % Improvement |
|---|---|---|---|
| Parameter | Uncoated Yeast | Coated yeast | (average) |
| Visits | 82 | 104 | 26.82 |
| Does/fawns | 190.75 | 271 | 42.07 |
| Bucks | 36.75 | 52.25 | 42.17 |
| Total deer | 227.5 | 323.25 | 42.09 |

¹Trial conducted with yeast grown on corn.

TABLE 4
Improvement of coated yeast compared to uncoated yeast when
added to pelleted feed on the attraction of deer to feeders¹

| | Number/treatment (average) | | % Improvement |
|---|---|---|---|
| Parameter | Uncoated Yeast | Coated yeast | (average) |
| Visits | 48 | 77.5 | 61.46 |
| Does/fawns | 95 | 202.5 | 113.16 |
| Bucks | 11.25 | 27 | 140.00 |
| Total deer | 106.25 | 229.5 | 116.00 |

¹Trial conducted with yeast grown on corn.

Conclusions—The dried yeast product grown on dried distiller's grain used in corn in Example 1 was no longer commercially available and a dried yeast product grown on corn was used in roasted soybeans and pelleted feed. The design of the trial was to demonstrate the improvement in attraction when coated yeast was added to a cereal grain, oil seed or pelleted feed, regardless of yeast source. The impact of dried yeast products will be evaluated in subsequent trials.

As observed with corn in Example 1, mixing the yeast with fat produced a slurry that attached to indentations and cracks in corn, roasted soybeans and peanuts (present in the whole grain deer feed). In the case of pelleted feed, fat coated yeast attached to the ends and sides of the pellets when added via post pelleting application. Distribution appeared uniform among kernels/pellets. No fat coated particles were found in the bottom of the mixer. In the case of dried yeast added directly to cereal grains, oilseeds (soybeans and peanuts) and pelleted feed, no attachment was noted.

The addition of dried yeast coated with fat to corn, oilseeds and pelleted feed was more effective in attracting deer to the feeders than when uncoated yeast was added to any of these matrices. This was demonstrated by the increased number of visits and increased number of deer visiting the feeders. This confirms that the use of fat coated yeast as an attractant to increase the number of visits and number of deer to the feeder can be used in cereal grains, oilseeds, pelleted feed, and mixtures thereof.

### Example 3—Impact of Coating of Dried Yeast when Added to Corn/Feed on Attracting Raccoons

Purpose—In trials conducted with corn (Example 1) and whole grain deer feed (Example 2) containing yeast grown on dried distillers grain, it was observed that raccoons demonstrated a tendency to visit feeders more frequently when the corn or whole grain deer feed contained fat coated yeast. This data was not captured at the time and additional trials were conducted to determine if coating dried yeast with fat will increase the attraction of raccoons to cereal grains, oilseeds or pelleted feed compared to uncoated dry yeast.

Experimental design—There were two experimental treatments per trial, 1) feed matrix containing fat coated yeast and 2) feed matrix containing uncoated yeast. Feed matrices used in the trials included corn, whole grain deer feed (43:43:14 ratio of corn:roasted soybean:peanuts), roasted soybeans or pelleted deer feed (17% protein). Treatments were prepared as described in Example 1.

Attractant trials were conducted at location 1. There were two trials conducted with each feed matrix in paired feeders. Each trial had two replicates/treatment of the uncoated and coated yeast product per trial. In the second trial, the positions of the treatments were reversed to eliminate any geographic location effect.

Results—The number of visits and number of raccoons for the 14-day trial period were averaged for each treatment (4 replicates/treatment). The average percent improvement due to the coating of the yeast was calculated. Results are presented in the following tables.

TABLE 5
Improvement of coated yeast compared to uncoated yeast when
added to corn on the attraction of raccoons to feeders

| | Number/treatment (average) | | % Improvement |
|---|---|---|---|
| Parameter | Uncoated Yeast | Coated yeast | (average) |
| Total Visits | 5.5 | 8 | 128.6 |
| Raccoons in | 0 | 0 | 0 |
| daytime | | | |
| Raccoons at night | 3.5 | 8 | 128.6 |
| Total Raccoons | 9.5 | 15 | 57.9 |

¹Trial conducted with yeast grown on corn.

TABLE 6
Improvement of coated yeast compared to uncoated yeast when added
to roasted soybeans on the attraction of raccoons to feeders

| | Number/treatment (average) | | % Improvement |
|---|---|---|---|
| Parameter | Uncoated Yeast | Coated yeast | (average) |
| Total Visits | 2.5 | 5.5 | 120 |
| Raccoons in | 0 | 2.5 | NA |
| daytime | | | |
| Raccoons at night | 5.75 | 12 | 108.7 |
| Total Raccoons | 5.75 | 14.5 | 152.2 |

¹Trial conducted with yeast grown on corn.

TABLE 7
Improvement of coated yeast compared to uncoated yeast when added
to pelleted feed on the attraction of raccoons to feeders

| | Number/treatment (average) | | % Improvement |
|---|---|---|---|
| Parameter | Uncoated Yeast | Coated yeast | (average) |
| Total Visits | 3 | 4.75 | 58.33 |
| Raccoons in | 0 | 0 | NA |
| daytime | | | |
| Raccoons at night | 4 | 8.75 | 118.75 |
| Total Raccoons | 4 | 8.75 | 118.75 |

¹Trial conducted with yeast grown on corn.

Conclusions—The addition of dried yeast coated with fat to corn, roasted soybeans and pelleted feed was more effective in attracting raccoons to the feeders than when uncoated yeast was added to these matrices. This was demonstrated by the increased number of visits and increased number of raccoons visiting the feeders. The number of daytime visits by raccoons to the coated fat treatment was surprising since raccoons are primarily nocturnal. This confirms that the use of fat coated yeast as an attractant to increase the number of visits and number of both deer and raccoons to the feeder can be used in cereal grains, oilseeds, pelleted feed of mixtures thereof.

### Example 4—Impact of Coating of Dried Yeast when Added to Corn on Attracting Feral Swine

Purpose—The purpose of these trials is to determine if coating active dried yeast in fat will increase the attraction of feral swine to corn compared to active dry yeast.

Experimental design—There were two experimental treatments per trial, corn containing 1.5% dried yeast and corn containing dried yeast coated in fat (equivalent to 1.5% dried yeast inclusion). The source of yeast used in these studies was yeast grown on corn. Treatments were prepared as described in Example 1

Attractant trials were conducted at location 3. There were two trials (two replicates/treatment) conducted in paired feeders. In the second trial, the positions of the treatments were reversed to eliminate any geographic location effect.

Results—The number of visits and number of feral swine for the 14-day trial period were averaged for each treatment (4 replicates/treatment). The average percent improvement due to the coating of the yeast was calculated. Results are presented in the following table.

TABLE 8
Improvement of coated yeast compared to uncoated yeast when
added to corn on the attraction of feral swine to feeders

| | Number/treatment (average) | | % Improvement |
|---|---|---|---|
| Parameter | Uncoated Yeast | Coated yeast | (average) |
| Daytime visits | 10.75 | 9.75 | −9.30 |
| Total Visits | 42 | 55.25 | 31.55 |
| Adult feral swine | 105.75 | 153.5 | 45.15 |
| Piglets | 38.5 | 40 | 3.90 |
| Total feral swine | 146.75 | 198 | 34.92 |

¹Trial conducted with yeast grown on corn.

Conclusions—The addition of dried yeast coated with fat to corn was more effective in attracting feral swine to the feeders than when uncoated dried yeast was added to corn. This was demonstrated by the increased number of visits and increased number of adult feral swine visiting the feeders. The number of piglets visiting the feeder is impacted by the piglets staying with their mother for nursing/protection.

### Example 5—Substituting Untreated Corn for Corn Containing Fat Coated Yeast on Attracting Deer

Purpose—It has been proposed that feeders, in general, attract deer to a specific geographic location and once learning the location of a feeder, deer will continue to visit the area in the same frequency regardless of the cereal grain, oilseed or feed used. The purpose of this experiment was to demonstrate that removal of the attractant (fat coated yeast) added to corn would result in a decrease in the number of visits and number of deer visiting the feeder.

Experimental design—The trial was conducted at location #1, where corn containing fat coated yeast was removed from the feeders in Example 1 and substituted with untreated corn. There were two replicates/treatment. Deer activity was monitored for 4 days for the untreated corn and compared to the previous 4 days when corn containing fat coated yeast was utilized.

Results—The number of visits and number of deer for the 4-day trial period were averaged for each treatment (2 replicates/treatment). The average percent decrease due to removal of the fat coated yeast from corn was calculated. Data is presented in the following table.

TABLE 9
Improvement of fat coated yeast over fat addition when
added to corn on the attraction of deer to feeders

| | Corn with fat coated yeast | Untreated corn | % Decrease |
|---|---|---|---|
| Parameter | (average) | (average) | (average) |
| #Visits | 65 | 31 | 52.3 |
| #Does/fawns | 75 | 45 | 40.0 |
| #Bucks | 9 | 4 | 55.6 |
| #Total deer | 84 | 49 | 41.2 |

¹Trial conducted with yeast grown on dried distillers grain.

Conclusions—The number of visits and number of deer attracted to the feeder decreased when untreated corn was used compared to the corn containing fat coated yeast. This disproves the assumption that once deer learn the location of a feeder they will continue to visit in the same frequency/number regardless of the cereal grain, oilseed or feed type used. It also confirms that fat coated yeast added to corn acts as an attractant.

### Example 6—Comparison of the Fat Versus Fat Coated Yeast on Deer Feeding Activity

Purpose—The purpose of these trials was to demonstrate that the deer attractant qualities of fat coated yeast when added to corn or roasted soybeans was due to the combination of the yeast and fat and not due to the effect of the fat alone.

Experimental design—There were two experimental treatments for each matrix, dried yeast coated in fat (equivalent to 1.5% dried yeast inclusion) and fat at a 1.5% inclusion rate. Corn/roasted soybeans containing fat coated yeast was produced as described in Example 1. In the case of the fat treated matrix, 475 ml of fat was added to corn or roasted soybeans while mixing. Two trials were conducted with each matrix at location 1 (2 replicates/treatment). Treatment locations in two corn trials as well as the two roasted soybean trials were reversed to eliminate location effect. The source of dried yeast used in Example #1 was no longer commercially available and a dried yeast product in which the yeast was grown on corn was used.

Results—The results of the studies conducted with fat or fat coated yeast were averaged (4 replicates/treatment) and the percent improvement due to the coating of the yeast determined. Results are presented in the following tables.

TABLE 10
Improvement of fat coated yeast over fat addition when
added to corn on the attraction of deer to feeders

| | Number/treatment (average) | | % Improvement |
|---|---|---|---|
| Parameter | Fat with no yeast | Fat coated yeast | (average) |
| Visits | 52.5 | 64.5 | 41.9 |
| Does/fawns | 80.5 | 136 | 68.9 |
| Bucks | 10 | 21 | 110.0 |
| Total deer | 90.5 | 157 | 73.5 |

¹Trial conducted with yeast grown on corn.

TABLE 11
Improvement of fat coated yeast over fat addition added
to roasted soybeans on the attraction of deer to feeders

| | Number/treatment (average) | | % Improvement |
|---|---|---|---|
| Parameter | Fat with no yeast | Fat coated yeast | (average) |
| Visits | 29 | 64.5 | 112.4 |
| Does/fawns | 44.5 | 168.5 | 278.7 |
| Bucks | 12.5 | 42 | 236.0 |
| Total deer | 57 | 210.5 | 269.3 |

¹Trial conducted with yeast grown on corn.

Conclusions—The studies in Example 6 demonstrate that the attractive quality of fat coated yeast was due to the combination of the coating agent (fat) and yeast and not due to the addition of fat to the cereal grain/oilseed.

### Example 7—Comparing Several Types of Yeast Products on Deer Feeding Activity

Purpose—It was observed that the dried yeast product (yeast grown on dried distiller's grain; no longer available for testing) used in Example 1 had a stronger aroma than that the dried yeast product (yeast grown on corn) used in Example 2 when coated in fat and added to corn, roasted soybeans, or pelleted feed. This noticeable difference was detected at the beginning of the experiments and when the feeders were emptied. Since aroma of the coated dried yeast containing volatile esters may be responsible for its attractant qualities, various sources of active dried yeast were evaluated for their attractant qualities.

Experimental design—The yeast products used in these trials includes the dried yeast grown on corn (CY), Brewer's yeast (BY; AniMed pure brewer's yeast), dried yeast grown on sugar cane (SY) and dried yeast grown on corn that had been treated with mild acid (HCL) to lyse intact cells (CY-HCL). Lysis consisted of treating 950 g of dried yeast with 50 ml of a hydrochloric: citric acid while mixing.

Yeast products were coated with fat as described in Example 1 and added to corn while mixing (1.5% dried yeast inclusion rate). Trials involved comparing the attractiveness of the individual coated yeast products to the coated CY yeast product. Three replicate feeding trials were conducted at the two locations. There were two replicates/trial at location #1 and 3 replicates/trial at location #2. Treatment locations were reversed between each trial.

Results—The results of the studies conducted at location 1 and 2 for each yeast product were averaged (15 replicates/treatment) and the percent improvement calculated. Results are presented in the following table.

TABLE 12
Comparison of dried yeast grown on corn to other yeast
products on the attraction of deer to feeders.

| | Average Improvement (%) compared to CY yeast | | |
|---|---|---|---|
| Parameter | SY | BY¹ | CY HCL |
| #Visits | −23.44 | −36.37 | 0.2 |
| #Does/fawns | −27.36 | −43.17 | 19.1 |
| #Bucks | −14.74 | −41.98 | 12.1 |
| #Total deer | −25.94 | −43.03 | 18.3 |

¹Number of replicates = 14 due to hunter removing SD cards at two paired feeders

Conclusions—These results indicate that the attractive quality of a coated dried yeast product added to corn for deer is dependent on the dried yeast product and is not obvious to one trained in the art. Dried yeast grown on sugar cane and brewer's yeast was less attractive to deer than dried yeast grown on corn. Differences in the aroma of the three dried yeast products were noted by the researcher.

It was noted that when the dried yeast grown on corn was subjected to mild acid treatment, the aroma of the product was stronger than the aroma of the untreated dried yeast product. This change in aroma appeared to improve its attractive qualities to deer. It is known that acid treatment of dried yeast can cause yeast cell walls to lysis. This can result in an increase in the release of intracellular esters trapped inside intact yeast cells.

### Example 8—Ester Analysis of Yeast Products

Purpose—Different yeast products were observed to vary in their effectiveness in attracting wildlife. This variation in aroma and attractiveness was thought to be due to their ester profiles (types and concentrations of acetate and ethyl esters).

Experimental design—Subsamples of the yeast products that were evaluated in feeding trials were stored at −5° C. until analysis. Analyses were conducted at an independent laboratory (Brewery Operations, School of Hospitality, Metropolitan State University of Denver, Denver, CO). Dry yeast (10 g) was weighed and transferred into a 500 mL boiling flask containing 200 mL of deionized water for distillation. The distillate (100 mL) was collected and 10 mL was transferred into a 20 mL headspace vial for gas chromatographic (GC) analysis. N-Butanol was used as an internal standard. External standards of the individual esters were prepared using GC-grade reagents in deionized water.

Samples were run on a Thermo Scientific Trace 1310 Gas Chromatograph with Triplus RSH Headspace Autosampler, and a Thermo TG Wax MS column, 30 m, 0.25 mm ID, 0.25 um film. Samples were agitated at 85° C. for 15 minutes, with a 10 sec on, 2 sec off cycle. 800 μL of headspace was collected and injected at 95° C. with a 1:9 split ratio. The concentration of the esters in the headspace gas was determined using a flame ionization detector.

Results—A linear regression was conducted with each external ester standard and the concentration of the acetate and ethyl esters in the distillates from the yeast products was calculated. The concentration of the esters in the yeast products is presented in Table 13. The levels of each ester in the particulate feed was calculated using the 1.5% inclusion rate of the yeast product and is presented in Table 14.

TABLE 13
Concentration of acetate and ethyl esters
in yeast products used in feeding trials

| | Level of ester (ppm) in different yeast products¹ | | | | |
|---|---|---|---|---|---|
| Ester | DY | CY | SY | BY | CY-HCL |
| Ethyl acetate | 11.5 | 0.6 | 0.4 | 10.3 | 0.6 |
| Isoamyl | <0.232² | 3.7 | 1.5 | 1.0 | 19.2 |
| acetate | | | | | |
| 2-Phenyl | 18.6 | 95.6 | 1.7 | 9.3 | 122.7 |
| acetate | | | | | |
| Ethyl | 340.0 | 0.6 | 0.5 | 1.7 | 2.8 |
| hexanoate | | | | | |
| Ethyl octanoate | 83.0 | 6.9 | 0.1 | 12.0 | 4.3 |
| Ethyl | 142.9 | 38.8 | 10.5 | 39.0 | 11.7 |
| decanoate | | | | | |
| Total | 595.9 | 146.2 | 17.7 | 73.3 | 161.3 |

¹Yeast products are as follows: yeast were grown on dried distillers grain (DY), yeast grown on corn (CY), yeast grown or sugar cane (SY), Brewer yeast (BY) and corn yeast (CY) hydrolyzed with mild acid (CY-HCL)
²Ester concentration was below the detection limit.

TABLE 14
Concentration of acetate and ethyl esters in the particulate feeds used in trials

| | Level of ester (ppm) in particulate feeds using the different yeast | | | | |
|---|---|---|---|---|---|
| | products | | | | |
| Ester | DY | CY | SY | BY | CY-HCL |
| Ethyl acetate | 0.17 | 0.01 | 0.01 | 0.15 | 0.01 |
| Isoamyl | <0.001 | 0.06 | 0.02 | 0.01 | 0.29 |
| acetate | | | | | |
| 2-Phenyl | 0.28 | 1.43 | 0.03 | 0.14 | 1.84 |
| acetate | | | | | |
| Ethyl | 5.10 | 0.01 | 0.01 | 0.032 | 0.04 |
| hexanoate | | | | | |
| Ethyl octanoate | 1.25 | 0.10 | 0.002 | 0.18 | 0.06 |
| Ethyl | 2.14 | 0.58 | 0.16 | 0.59 | 0.18 |
| decanoate | | | | | |
| Total | 8.94 | 2.19 | 0.22 | 1.10 | 2.42 |

Conclusions—The ester profiles of the five yeast products were different. In the yeast product obtained from growing yeast on dried distillers grain, higher levels of ethyl esters compared to acetate esters were present. This product was the most effective in attracting wildlife. The yeast product obtained by growing yeast on corn was the second most effective product in attracting wildlife. It was found to contain higher levels of acetate esters than ethyl esters. Partial acid hydrolysis of this product increased its effectiveness and the level of acetate esters. This suggests that the attractiveness of the yeast product is related to the type and concentration of both acetate and ethyl esters. The level of the individual esters in the particulate feed ranged from 0.1 to 5.10 ppm. Total acetate and ethyl ester concentration raged from 0.22 to 8.94 ppm in the particulate feed.

### Example 9—Comparing Several Types of Coating Agents Applied to Dried Yeast on Deer Feeding Activity

Purpose—Fat (hydrogenated vegetable shortening) was used as a coating agent for dried yeast in Examples 1-7 due to 1) it would adhere to the outer surface of feed/feed ingredients and 2) it has high melting point (117-119° F.; would not easily melt and plug the feeder). Other potential coating agents that have similar chemical properties include medium and long chain fatty acids, ethoxylated castor oils, and polysorbates.

Experimental design—The dried yeast product in these trials was dried yeast grown on corn (CY). Coating agents that were evaluated included fat, ethoxylated castor oil (CO-40), polysorbate 60, polysorbate 80 and caprylic acid (C-8 medium chain fatty acid). CY yeast (340 g) was mixed with 475 ml of the different coating agents and mixed with corn (1.5% dried yeast inclusion rate) as described in Example 1. Ethoxylated castor oil and polysorbate-80 did not have to be heated prior to mixing with CY. Polysorbate-60 was too viscous at room temperature and was warmed in a sonication water bath at 35° C. prior to use.

Trials involved comparing the attractiveness of fat coated CY yeast to CY yeast coated with one of the other coating agents. Three replicate feeding trials were conducted at the two locations. There were two replicates/trial at location 1 and 3 replicates/trial at location 2. Treatment locations were reversed between each trial.

Results—The number of visits and number of deer for the three 14-day trial periods at location 1 and 2 were averaged for each treatment (15 replicates/treatment). Results are presented in the following table.

TABLE 15
Comparison of yeast coated with fat to yeast coated
with other coating agent on deer feeding activity

| | Average Improvement (%) Compared to Fat Coated Yeast | | | |
|---|---|---|---|---|
| | | Polysorbate | Polysorbate | |
| Parameter | CO-40¹ | 60 | 80 | Caprylic acid |
| #Visits | 27.5 | −27.0 | 39.6 | 20.0 |
| #Does/fawns | 34.9 | −24.9 | 59.7 | 26.5 |
| #Bucks | 44.9 | −28.6 | 46.3 | 62.1 |
| #Total deer | 36.0 | −10.7 | 59.3 | 37.1 |

¹Number of replicates = 14 due to a camera malfunction at one of the two paired feeders

Conclusions—In Examples 1-7, fat (vegetable shortening) was used as a coating agent for the dried yeast products to both adhere the yeast product to the cereal grain/oilseed/feed and to retain the aroma of the dried yeast product on the corn/oilseed/feed for a longer period of time. Other coating agents, such as ethoxylated castor oil, medium chain fatty acid (C-8) and polysorbate, were evaluated for their effectiveness in retaining the attractive quality of the dried yeast when added to corn. It was observed that ethoxylated castor oil, polysorbate 80 and C-8 fatty acid were more effective than fat in retaining the attractive quality of yeast when added to corn. Yeast coated with polysorbate 80 was observed to attract more does than other coating agents, while yeast coated with C-8 fatty acid attracted more bucks, especially more adult bucks (97.1% increase). The effect of yeast coated with caprylic acid in attracting adult bucks is a non-predictable effect based on prior literature. Bean and Mason (1995), Crawford and Church (1971), and Rice and Church (1974) have all reported that mature bucks are less likely to respond to attractants than does and yearlings.

In the case of polysorbate 60, the addition of polysorbate 60 coated yeast to corn appeared to reduce the flowability of the corn in the WildGame Innovation feeders. Since trials were conducted over an 18-month period, the impact of environmental temperature on the flowability of the various product combinations in each type of feeder was closely monitored. No issues with product flowability were observed with the exception of polysorbate 60 coated yeast. In the first trial conducted in March at location #1, it was observed that only 24.3% of the intended volume of the corn was dispensed from feeders. The average environmental temperature during the trial ranged from 48-68° F. The flowability issue was believed to be due to the viscosity of polysorbate 60 at low temperatures and subsequent trials (trials 2 and 3) were conducted in July-August when the environmental temperature was higher (79-86° F.) to determine if flowability improved. However, no improvement in flowability was observed at the higher environmental temperature.

No flowability issues were observed in the Game Winner feeders used at location 2 in trials 1 (environmental temperature ranged from 48-68° F.), 2 or 3 (environmental temperature was ranged from 79-86° F. for trials #2 and #3). This difference in the flowability between the WildGame Innovation and Game Winner feeder is thought to be due to feeder design. The angle of the cone at the bottom of the WildGame Innovation feeder was greater than the Game Winner feeder and the aperture opening was smaller. This flowability issue at location #1 appeared to influence the attractiveness of the coated yeast treated corn when compared to the results of location #2.

Environmental temperatures also appeared to impact the aroma released from polysorbate 60 coated yeast treated corn at location #2 where flowability was not an issue. In the first trial conducted in March, coating of the yeast with polysorbate 60 attracted less (−28.5% less) deer than fat coated yeast. However, in trials 2 and 3 conducted in July-August, coating of the yeast with polysorbate 60 attracted more (averaged of 35.8% more) deer than fat coated yeast. This suggests that some coating agents may impair the release of the aroma from the yeast at lower environmental temperatures.

### Example 10—Evaluating the Attractiveness of Acetate and Ethyl Esters Coated in CO-40 when Added to Corn in Deer, Raccoons, and Feral Swine

Purpose—Dried yeast contains many distinct types of volatile compounds, including acetate and ethyl esters. The literature reports that the concentration of acetate esters in dried yeast can vary from 0.4 ppm to 63.6 ppm (Yoshioka et al, 1983; Saerens et al, 2010) while the level of ethyl esters ranges from 0.04 to 154 ppm (Saerens et al, 2010; Mantzouridou et al, 2015). A mid-range level of 30 ppm in yeast of select acetate and ethyl esters when added to corn at 1% was to evaluate the attractiveness to deer, raccoons, and feral swine.

Experimental design—Ethyl acetate, 2-phenyl acetate, isoamyl acetate, ethyl hexanoate and ethyl octanoate were acquired from Sigma (95-99% purity). Ethyl decanoate was acquired from TCI (99% purity). Stock solutions (300 ppm) of individual esters were made in CO-40 based on the higher attractiveness with CY coated with CO-40 observed in deer and raccoons in Example 8. CO-40 (450 g) was weighed on an Ohaus balance in 500 ml screwcap Nalgene bottlers. Esters (150 mg) were added with a 100-1000 μl Eppendorf pipet (volume added calculated using density of the ester). Immediately after adding the ester, the bottle was sealed and shaken vigorously.

CO-40 containing the different esters were added to corn to obtain a final ester concentration in the particulate feed of 1.3 ppm. Treated corn was prepared 24 hours prior to testing. The attractiveness of the different esters in deer and raccoons was evaluated at location 1 by placing the treated corn in a tube feeder (3 replicate trials). The attractiveness of the different esters to swine was evaluated at location 3 by placing the corn on the ground (feral swine will destroy tube feeders) at 4 different locations. Wild game activity was monitored using a Moultrie game camera A-30 (location 1) or Moultrie game camera AC-450 (location 3). The camera started capturing data on an SD card 30 seconds of initial movement.

Results—When a deer, raccoon or feral swine first appeared at the treatment location, the time was recorded. The time between the placement of the treated corn and the first appearance of the animal was calculated for each trial. The average time to first visit for the three trials is presented in the following table.

TABLE 16
Average time to first visit by deer, raccoons, and feral swine

Average Time to First Visit (hrs)

| Ester | Deer | Raccoons | Swine |
|---|---|---|---|
| Ethyl acetate | 7.29 | 2.99 | 6.98 |
| 2-Phenyl acetate | 3.75 | 3.89 | 8.11 |
| Isoamyl acetate | 8.73 | 12.68 | 7.74 |
| Ethyl hexanoate | 6.73 | 12.53 | 8.46 |
| Ethyl octanoate | 12.71 | 11.33 | 13.72 |
| Ethyl decanoate | 3.37 | 9.52 | 10.01 |

Conclusions—In the trials conducted at location 1, trials were conducted in late spring-early summer to eliminate any effect of sex distraction that occurs during mating season. The location of feeders at location 1 was considered to eliminate any effect of fear of predation, disturbance, competition between animal species, alternate feeding sources, etc. No competition was observed between deer and raccoons. Feral swine trials at location 3 were conducted in early fall. The location of feeders at location 3 was also considered any effect of fear of predation, disturbance, competition between animal species, alternate feeding sources, etc. In addition to swine visiting the feed containing the esters, deer and raccoons were observed to visit on an inconsistent basis. It is known that feral swine visiting a feeder greatly impacts deer and raccoon visitations (competition between species; Snow et al 2020).

The time of the first visit to the feeder by deer, raccoons and feral swine was different for the various esters. Ethyl hexanoate, ethyl decanoate and 2-phenyl acetate attracted deer to the feeders in a shorter period of time than ethyl acetate, isoamyl acetate or ethyl octanoate at the concentration tested. In the case of raccoons, ethyl acetate and 2-phenyl acetate attracted raccoons to the feeders in a shorter period of time than ethyl decanoate. Raccoons, which are primarily nocturnal, made more daytime visits (6 am-8 pm) to feeders containing 2-phenyl acetate, ethyl acetate and ethyl decanoate than the other esters. In the case of swine, ethyl acetate and isoamyl acetate were more effective in attracting wild swine than the other esters. These data suggest that different esters at a final ester content in corn of 1.3 ppm may be more attractive to one species than another.

### Palatability Trials

The dispensing type feeders used in Examples 1 through 8 are a useful tool for measuring the attractant qualities of the coated dried yeast when incorporated into cereal grains, oilseeds, or pelleted feed. However, the use of stationary type feeders in which an animal has free access to feed in a contained device provide better insight on the palatability of cereal grains, oilseeds or feed when amended with coated dried yeast. This is similar to the trial format used to test palatability of foods in other animal species, such as dogs and cats.

Stationary tube feeders consisted of a 4-foot section of 4″ PVC connected to a 45-degree PVC angle at the bottom to allow wildlife access to the corn. A wire screen was mounted to the bottom of the 45-degree angle to allow any rainwater entering the angle to drain preventing spoilage of the corn during the trial. The tops of the feeders were capped to prevent water entry due to rain.

In these trials, there were four identical feeders spaced 6 feet apart. Feeders were mounted on steel t-post and the bottom of the feeder was 8 inches off the ground. Deer, raccoons, and other wildlife had free choice of which feeder to visit.

In these palatability trials, geographic location and seasonality do not impact variability due to the trial design. Trials were conducted at a single site (on the edge of a thicket in the floodplain) at location 1.

### Example 11—Impact of Coated Yeast Added to Corn or Soybeans on Feeding Time in Deer

Purpose—In the trials conducted to demonstrate the attractiveness of coated dried yeast added to corn or roasted soybeans, it appeared that deer may be visiting the feeders for longer periods of time than the dried yeast added to corn. This suggests that the coating of the yeast product coated with fat may improve the palatability of the corn or soybean as well.

Experimental design—Experimental design of the trial is presented in Example 2. In addition to monitoring the number of visits and number of deer, the time when deer appeared and time when deer left the feeder area was recorded. Only data from location 1 was used in the analysis due to the difficulties in capturing the data (i.e., no known process exists for transposing time data on a SD card into Excel format for analysis and data had to be manually recorded).

Results—Data from the corn and soybeans containing dried yeast coated with fat were averaged to focus on the effect of the fat only. Similarly, data from the corn and soybeans containing fat only were averaged for treatment. Data is presented in the following table.

TABLE 15
Comparison of fat coated yeast with
fat only on deer feeding activity.

| | Number/treatment (average) | | % Improvement |
|---|---|---|---|
| Parameter | Fat | Fat coated yeast | (average) |
| Visits | 39 | 78 | 100 |
| Does/fawns | 59 | 167 | 183.1 |
| Bucks | 14 | 21 | 50 |
| Total deer | 73 | 188 | 157.5 |
| Time (min) at | 10-30 | 1-48 | NA |
| feeder (range) | | | |
| Ave time (min) | 5.54 | 9.97 | 80.0 |
| at feeder | | | |

Conclusions—Time data from the SD cards indicates that deer spent longer periods of time at feeders dispensing corn/soybeans containing fat coated yeast versus feeders containing corn/soybeans treated with fat. Since feeders are only dispensing ˜1.5 lb. of corn/soybean per time interval (2 times/day), this feed would be consumed in only a manner of a few minutes/visits. The fact that deer appear to be searching for corn/soybean containing fat coated yeast suggests that it may be more palatable. Due to the significant amount of time required to obtain the data presented in Table 1, a different trial design was used to further explore the palatability of coated yeast.

### Example 12—Evaluating the Palatability of Fat Coated Yeast Versus Yeast when Added to Corn, Roasted Soybean, or Pelleted Deer in Deer and Raccoons

Purpose—The purpose of these trials was to compare the palatability of active dried yeast (CY) coated in fat to active dried yeast when added to corn, roasted soybeans, or pelleted feed.

Experimental design—Active dried yeast grown on corn (CY) was coated in fat as described in Example 1 and added to corn, roasted soybeans, or pelleted feed while mixing (1.5% dried yeast inclusion rate). The second treatment involved adding uncoated dried yeast to the same matrices at 1.5% inclusion rate. There were two experimental treatments in each trial and two replicates/treatment. Trials were replicated in triplicate with treatment positions reversed in each trial.

The feed matrix containing the coated dried yeast product (10 lb.) or dried yeast was added to each tube feeder and the volume of corn recorded. Treatment positions were alternated among the 4 tube feeders. In the second trial, treatment positions were reversed to eliminate any positional bias. In the third trial, treatment positions were again reversed.

Feeders were checked daily (11-12 am) from a distance of 25-30 ft. Trials were terminated when any feeder did not contain a visible amount of feed (typically 4 days) or after 6 days in the case of pelleted feed (feed after 7 days is prone to mold growth). Feeders were emptied and the remaining feed weighed. Feed consumption was calculated. When a deer or raccoon fed at a specific feeder in the video, it was recorded.

Results—Preference was calculated by the number of deer or raccoons consuming a treatment divided by the total number of animals visiting all treatments. It was noticed that other animals visited the feeders (i.e., opossums, squirrels, wild birds) but not on a consistent basis. The percent feed consumption, percent preference in deer and percent preference in raccoons was averaged for the 3 trials. Data is presented in the following table.

TABLE 18
Palatability of feed matrices with fat coated yeast compared
to matrices with only yeast in deer and raccoons

| | % Feed | | % Preference | | % Preference in | |
|---|---|---|---|---|---|---|
| | Consumption | | in Deer | | Raccoons | |
| | (average) | | (average) | | (average) | |
| | Uncoated | Coated | Uncoated | Coated | Uncoated | Coated |
| Matrix | Yeast | Yeast | Yeast | Yeast | Yeast | Yeast |
| Corn | 32.4 | 58.2 | 33.5 | 66.5 | 41.4 | 58.6 |
| Soybeans | 12.2 | 47.9 | 30.8 | 69.2 | 31.2 | 68.8 |
| Pelleted | 5.9 | 34.7 | 35.8 | 64.2 | 32.7 | 67.3 |
| feed | | | | | | |

Conclusions—Any effect end-bias on consumption was negated by the trial design. Treatment position was randomized in which tubes 1 and 3 had one treatment and tubes 2 and 4 had the second treatment. Reversing treatment position between the three trials also minimized any positional effect. Deer and raccoons preferred bait/feed containing fat coated yeast over bait/feed containing uncoated yeast by a 2:1 ratio based on preference data.

Consumption of the baits/feeds over the trial period varied based on bait/feed type. It was observed that deer and raccoons spent more time feeding on corn and roasted soybeans than when feeding on pelleted deer feed. In the case of pelleted deer feed, deer would appear to take a mouthful then leave the tube feeder.

The coating of the yeast product with fat increased consumption in both deer and raccoons. In the case of corn, there was a 73.2% increase in consumption of the corn containing the fat coated yeast compared to the corn containing just the dried yeast. In the case of roasted soybeans, there was a 292.6% increase in consumption and in the case of pelleted deer feed, a 488.1% increase in consumption was observed.

### Example 13—Evaluating the Palatability of Fat Coated Yeast Versus Fat Added to Corn in Deer and Raccoons

Purpose—The purpose of these trials was to demonstrate that the palatability of fat coated dried yeast in deer and raccoons when added to corn was due to the combination of the yeast and fat and not due to the effect of the fat alone.

Experimental design—Treatments were prepared as described in Example 6. Trials involved comparing the palatability of corn containing the coated yeast corn containing fat alone. There were two experimental treatments in each trial and two replicates/treatment. Trials were replicated in triplicate with treatment positions reversed in each trial.

Corn containing the coated dried yeast product (10 lb.) or corn containing fat alone was added to each tube feeder and the volume of corn recorded. Treatment positions were alternated among the 4 tube feeders. There were two treatments/trial with 2 replicates. Monitoring of the feeders and data capture were as described in Example 11.

Results—Preference was calculated by the number of deer or raccoons consuming a treatment divided by the total number of deer or raccoons. The percent feed consumption, percent preference in deer and percent preference in raccoons was averaged for the 3 trials. Data is presented in the following table.

TABLE 19
Improvement of fat coated yeast over fat addition when
added to corn on the palatability in deer and raccoons

| | Percent/treatment (average) | | |
|---|---|---|---|
| | Fat with | Fat coated | % Improvement |
| Parameter | no yeast | yeast | (average) |
| Consumption | 86.4 | 82.4 | −4.6 |
| Preference in deer | 34.7 | 65.3 | 88.2 |
| Preference in | 42.9 | 57.1 | 33.1 |
| raccoons | | | |

Conclusions—These studies demonstrate that the improvement in palatability of coated yeast product added to corn was due to the combination of the coating agent (fat) and yeast and not due to the addition of fat to the cereal grain/oilseed. Deer visited tube feeders containing corn with fat coated dried yeast 1.88 times more frequently than tube feeders containing corn treated with fat whereas raccoons visited 1.33 times more frequently.

### Example 14—Evaluating the Palatability of Fat Coated Yeast Products Added to Corn in Deer and Raccoons

Purpose—The purpose of these trials was to compare the palatability of active dried yeast (CY) coated in fat to other dried yeast products (i.e., SY, BY and CY-HCL) coated in fat when added to corn.

Experimental design—Yeast products were coated in fat as described in Example 1 and added to corn while mixing (1.5% dried yeast inclusion rate). Trials involved comparing the palatability of the individual coated yeast products to the coated CY yeast product. There were two experimental treatments in each trial and two replicates/treatment. Trials were replicated in triplicate with treatment positions reversed in each trial.

Corn containing the coated dried yeast product (10 lb.) was added to each tube feeder and the volume of corn recorded. Monitoring of the feeders and data capture were as described in Example 11.

Results—Preference was calculated by the number of deer or raccoons consuming a treatment divided by the total number of deer or raccoons. The percent feed consumption, percent preference in deer and percent preference in raccoons was averaged for the 3 trials. Data is presented in the following table.

TABLE 20
Comparison of corn with fat coated CY versus corn with other
yeast coated in fat on palatability in deer and raccoons

| | % Feed | | % Preference | | % Preference in | |
|---|---|---|---|---|---|---|
| | Consumption | | in Deer | | Raccoons | |
| | (average) | | (average) | | (average) | |
| Yeast | | Other | | Other | | Other |
| type | CY | Yeast | CY | Yeast | CY | Yeast |
| SY | 94.8 | 91.9 | 48.7 | 51.3 | 50.9 | 49.1 |
| BY | 90.1 | 74.9 | 58.0 | 42.0 | 91.7 | 8.3 |
| CY HCL | 78.1 | 91.5 | 63.8 | 36.2 | 33.1 | 66.9 |

Conclusions—In attractant trials conducted with different yeast products coated in fat (Example 7), CY-HCL attracted more deer than CY. In palatability trials, CY-HCL was also more palatable to deer and raccoons than CY. This would indicate that the attraction qualities and palatability of the coated yeast product are correlated as suggested in the prior art. In attractant trials conducted with fat coated CY and fat coated SY, fat coated CY attracted more deer than fat coated SY. However, their palatability to deer and raccoons were essentially the same in these tube feeder trials. This indicates that attractive and palatability qualities of an attractant are not correlated contrary to the prior art. Fat coated BY attracted the least number of deer compared to fat coated CY in the attractant trials and was less palatable to deer in these trials. The lack of palatability of the fat coated BY in raccoons suggests that palatability of fat coated yeast varies among animal species.

### Example 14—Evaluating the Palatability of CY when Coated with Various Coating Agents when Added to Corn in Deer and Raccoons

Purpose—The purpose of these trials was to compare the palatability of active dried yeast (CY) coated in fat to active dried yeast (CY) coated with ethoxylated castor oil, polysorbate 60, polysorbate 80, medium chain fatty acid (caprylic acid; C-8) or long chain fatty acid (myristic acid; C-14).

Experimental design—The dried yeast product in these trials was dried yeast grown on corn (CY). Coating agents that were evaluated included fat (vegetable shortening), ethoxylated castor oil (CO-40), polysorbate 60, polysorbate 80, caprylic acid (medium chain fatty acid) and myristic acid (long chain fatty acid). CY yeast (340 g) was mixed with 475 ml of the different coating agents and mixed with corn (1.5% dried yeast inclusion rate) as described in Example 1. Ethoxylated castor oil, polysorbate-80 and caprylic acid did not have to be heated prior to mixing with CY. Polysorbate 60 was too viscous at room temperature and was warmed in a sonication water bath at 35° C. prior to use. Myristic acid was in a dry powder form and was melted in a sonicating water bath at 65° C. prior to use. Trials involved comparing the palatability of CY coated with the individual coating agents to the fat coated CY yeast product. There were two experimental treatments in each trial and two replicates/treatment. Trials were replicated in triplicate with treatment positions reversed in each trial.

Corn containing the coated dried yeast product (10 lb.) was added to each tube feeder and the volume of corn recorded. Monitoring of the feeders and data capture were as described in Example 11

Results—Preference was calculated by the number of deer or raccoons consuming a treatment divided by the total number of deer or raccoons. The percent feed consumption, percent preference in deer and percent preference in raccoons was averaged for the 3 trials. Data is presented in Table 1.

TABLE 21
Comparison of corn with CY coated with fat versus CY coated with
other coating agents on palatability in deer and raccoons

| | % Feed | | | | % Preference in | |
|---|---|---|---|---|---|---|
| | Consumption | | % Preference in | | Raccoons | |
| Coating | (average) | | Deer (average) | | (average) | |
| agent | Fat | Agent | Fat | Agent | Fat | Agent |
| CO-40 | 38.7 | 100 | 25 | 75 | 5.5 | 94.5 |
| Polysorbate | 100 | 40.7 | 71.6 | 28.4 | 87.2 | 12.8 |
| 60 | | | | | | |
| Polysorbate | 95.1 | 68.7 | 64.0 | 36.0 | 67.0 | 33.0 |
| 80 | | | | | | |
| Caprylic acid | 95.4 | 89.5 | 31.6 | 68.6 | 64.7 | 35.3 |
| Myristic acid | 99.4 | 98.5 | 40.7 | 59.3 | 41.5 | 58.5 |

Conclusions—In attractant trials, CO-40, polysorbate 80 and caprylic acid were observed to be more effective coating agents for dried yeast than fat when added to corn in the attraction of deer (Example 8). However, in palatability trials, only yeast coated with CO-40 or caprylic acid were more palatable than yeast coated with fat in both deer and raccoons. Yeast coated with polysorbate 80, while an effective attractant, had a negative effect on palatability. In the case of polysorbate 60, it was the coating agent with the least attractive quality and the least palatable. Myristic acid (melting point of 57° C.) was not evaluated in the attractant trials conducted in Example 8 due to the difficulties in making sufficient quantities of the coated yeast product necessary for treating 750 lbs. of corn. However, in palatability trials (60 lb. of corn treated), myristic acid coated yeast was more palatable than fat coated yeast when added to corn. This further supports that attractive and palatability qualities of attractant are not correlated as suggested in the prior art.

### Example 16—Evaluating the Palatability of Acetate and Ethyl Esters Coated in CO-40 when Added to Corn in Deer and Raccoons

Purpose—Dried yeast contains many distinct types of volatile compounds, including acetate and ethyl esters. The literature reports that the concentration of esters can vary from 0.4 ppm (Yoshioka et al, 1983) to 63.6 ppm (Saerens et al, 2010) depending upon yeast strain, fermentation conditions and fermentation substrate. A mid-range level of 30 ppm of select acetate and ethyl esters when added to corn at 1% was to evaluate the attractive and palatability qualities in deer and raccoons.

Experimental design—Ethyl acetate, 2-phenyl acetate, isoamyl acetate, ethyl hexanoate and ethyl octanoate were acquired from Sigma (95-99% purity). Ethyl decanoate was acquired from TCI (99% purity). Stock solutions (300 ppm) of individual esters were made in CO-40 based on the higher palatability with CY observed in deer and raccoons in Example 8. CO-40 (450 g) was weighed on an Ohaus balance in 500 ml screwcap Nalgene bottlers. Esters (150 mg) were added with a 100-1000 μl Eppendorf pipet (volume added calculated using density of the ester). Immediately after adding the ester, the bottle was sealed and shaken vigorously.

There were two experimental treatments in each trial and two replicates/treatment. CO-40 was used as the positive control in all trials. CO-40 (100 ml) and the ester (50 ml diluted with 50 ml of CO-40) was added to 25 lb. of corn while mixing. This volume of ester stock solution added to corn results in a final ester concentration in the corn of 1.3 ppm. Treated feed was prepared 24 hours prior to testing. Trials were replicated in triplicate with treatment positions reversed in each trial.

Corn containing the CO-40 or the ester suspended in CO-40 (10 lb.) was added to each tube feeder and the volume of corn recorded. Monitoring of the feeders and data capture were as described in Example 11.

Results—Preference was calculated by the number of deer or raccoons consuming a treatment divided by the total number of deer or raccoons. The percent preference in deer and in raccoons was averaged for the 3 trials. Data is presented in the following tables.

TABLE 22
Comparison of esters coated in ethoxylated castor oil to
castor oil when added to corn on palatability in deer

| | Number of | % Total | | |
|---|---|---|---|---|
| | deer | deer | % Preference | % Preference |
| | visiting | preference | in does | in bucks |
| Ester | (average) | (average) | (average) | (average) |
| Ethyl acetate | 69.67 | 62.53 | 61.90 | 58.60 |
| 2-Phenyl acetate | 37.33¹ | 74.30 | 45.59 | 80.00 |
| Isoamyl acetate | 28.67 | 59.30 | 45.00 | 69.32 |
| Ethyl hexanoate | 71.33 | 63.67 | 65.87 | 62.60 |
| Ethyl octanoate | 52.33 | 56.23 | 53.57 | 45.49 |
| Ethyl decanoate | 55.33 | 58.53 | 53.19 | 58.62 |

¹All 2-Phenyl acetate containing feed was consumed within 24-36 hrs. which was not observed with the other esters tested.

TABLE 23
Comparison of esters coated in ethoxylated castor oil to
castor oil when added to corn on palatability in raccoons

| | Number of | % Daytime | |
|---|---|---|---|
| | raccoons | visits | % Preference |
| Ester | visiting (average) | (average) | (average) |
| Ethyl acetate | 15.3 | 32.7 | 54.5 |
| 2-Phenyl | 6.7 | 79.6 | 49.5 |
| acetate | | | |
| Isoamyl acetate | 7 | 10 | 18.1 |
| Ethyl hexanoate | 12 | 14.2 | 52.8 |
| Ethyl octanoate | 6.7 | 19.4 | 45.2 |
| Ethyl decanoate | 9.3 | 32.3 | 50.8 |

Conclusions—All of the esters suspended in CO-40 and added to corn were more palatable than CO-40 added to corn alone. 2-Phenyl acetate was observed to be the most palatable of these esters to deer. Deer spent longer feeding and consumed all of the feed in 24-36 hrs. which was not seen with any of the other esters. Bucks also had a higher preference for 2-phenyl acetate than does. Three distinct groups of bucks (10 different bucks; one adult buck in each group) were recorded. Bucks also had a higher preference for isoamyl acetate than does. Preference for the other esters was not different among sexes.

The improvement in the palatability of the esters suspended in CO-40 and added to corn in raccoons was not as dramatic. Ethyl acetate and ethyl hexanoate were slightly more palatable than CO-40. Raccoons did not appear to find isoamyl acetate in corn at final concentration of 1.3 ppm.

As demonstrated in Examples 11-13, coated active dried yeast containing both acetate and ethyl esters improved the palatability of corn in raccoons. The CY product used in these trials was found to contain a mixture of these esters including ethyl acetate, 2-phenyl acetate, ethyl hexanoate, ethyl octanoate and ethyl decanoate. Palatability of individual acetate and ethyl esters in raccoons as well as deer may be improved by using different combinations and levels.

Having illustrated and described the principles of the present invention, it should be apparent to persons skilled in the art that the invention can be modified in arrangement and detail without departing from such principles.

Although the materials and methods of this invention have been described in terms of various embodiments and illustrative examples, it will be apparent to those of skill in the art that variations can be applied to the materials and methods described herein without departing from the concept, spirit, and scope of the invention. All such similar substitutes and modifications apparent to those skilled in the art are deemed to be within the spirit, scope and concept of the invention as defined by the appended claims.

### CITATIONS

### US Patents

US Patent App 2010/0278967 November 2008 Crespo
U.S. Pat. No. 4,125,629 A November 1978 Rossi
U.S. Pat. No. 11,044,926 B2 April 2016 Crespo

### OTHER REFERENCES

Snow, N. P., C. A. Kupferman, M. J. Lavelle, K. M. Pepin, M. H. Melton, W. J. Gann, K. C. VerCauteren and J. C. Beasly. 2022. No panacea attractant for wild pigs (Sus scrofa), but season and location matter. Appl. Anim. Behav. Sci. 105705. https://doi.org/10.1016/j.applanim.2022.105705
Rice, P. R., and D. C. Church. 1974. Taste response of deer to browse extracts, organic acids, and odors. J. Wildl. Manage. 38(4):830-836.
Dasman, R. F. R. L. Hubbard, W. M. Longhurst, G. I. Ramstead, J. H. Harn, and E. Calvert. 1967. Deer attractants: An approach to the deer damage problem. J. Forestry. 65(8):564-566.
Crawford, J. C., and D. C. Church. 1971. Response of black-tailed deer to various chemical taste stimuli. J. Wild. Manage. 35(2):201-215.
Hakim, S. W. J. McShea and J. R. Mason. 1996. The attractiveness of a liquid bait to white-tailed deer in the central Appalachian Mountains, Virginia, USA. J. Wildl. Dis. 32(2); 395-398.
Mason, R. J., N. J. Bean and L. Clark. 1993. Development of chemosensory attractants for white tailed deed (Odocoileus virginianus). Crop Protect. 12(6): 448-452.
Bean, N. J., and J. R. Mason. 1995. Attractiveness of liquid baits containing natural and artificial sweeteners to white-tailed deer. J. Wildl. Manage. 59(3):610-613.
Campbell, T. A. and D. B. Long. 2008a. Mammalian visitation to candidate feral swine attractants. J. Wildl. Manage. 72(1):305-309.
Campbell, T. A. and D. B. Long. 2008b. Strawberry-flavored baits for pharmaceutical delivery to feral swine. Wildl. Manage. 73:615-619.
Snow, N. P., J. M. Halseth, M. J. Lavelle, T. E. Hanson, C. R. Blass, J. A. Foster, S. T. Humphreys, L. D. Staples, D. G. Hewitt, and K. C. VerCauteren. 2016. Bait preference of free-ranging feral swine for delivery of a novel toxicant. PloS ONE 11(1): e0146712.doi: 10.1371/journal.pone.0146712.
Fadiac, E. 2019. Managing deer: attractants, repellents, invasion modelling and impact assessment. PhD. Testis. Queens University, Belfast
Wyckoff, A. C., S. E. Henke, T. Campbell, and K. C. Vercauteren. 2006. Is trapping success of feral hogs dependent upon weather conditions? Proc. 22^{nd} Vertbr. Pest. Conf. (R. M. Timm and J. M. O'Brien, Eds.) Published at Univ. of Calif., Davis. Pp. 370-372.
Williams, B. L., R. W. Holtfretter, S. S. Ditchkoff and J. B. Grand. 2011. Efficiency of time-lapse intervals and simple baits for camera surveys of wild pigs. J. Wildl. Manag. 75(3):655-659.
Karlin, M. L. and H. A. Khan. 2020. Determining feral pig (Sus scrofa) attractant selection preference and response to mock corral traps. Texas J. Sci. 72(1): Article 1. https://doi.org/10.32011/txjssci_72_1_article 1.
Shurson, G. C. 2018. Yeast and yeast derivatives in feed additives and ingredients: Sources, characteristics, animal responses and quantification methods. Animal Feed Sci. Tech. 235:60-76
Saerens, S. M. G., K. J. Verstrepen, S. D. M. VanLaere, A. R. D. Voet, P. VanDijck, F. R. Delvaus and J. M. Thevelein. 2006. The Saccharomyces cerevisiae EHT1 and EEB1 genes encode novel enzymes with medium-chain fatty acid ethyl ester synthesis and hydrolysis capacity. J. Bio. Chem 281(7):4446-4456.
Nykanen, L, and I. Nykanen. 1977. Production of esters by different yeast strains in sugar fermentations. J. Inst. Brew. 83(1):30-12.
Yunoki, K. S. Hirose and M. Ohnishi. 2007. Ethyl esterification of long-chain unsaturated fatty acids derived from grape must by yeast during alcoholic fermentation. Biosci. Biotechnol. Biochem. 72(12):3105-3109.
Saerens, S. M. G., F. R. Delvaux, K. J. Verstrepen and J. M. Thevelein. 2010. Production and biological function of volatile esters in Saccharomyces cerevisiae. Micro. Biotech. 3(2):165-177.
Yoshioka and N. Hashimoto. 1983. Cellular fatty acid and ester formation by brewers yeast. Agric. Biol. Chem. 47(10):2287-2294
Nordstrom, K. 1964. Formation of esters from acids by brewer's yeast. IV. Effect of higher fatty acids and toxicity of lower fatty acids. J. Inst. Brew. 70:233-242.

What is claimed is:

1. An attractant and/or palatant composition for application of an effective amount to a particulate feed that is suitable for a non-carnivorous mammal, the composition comprising a mixture that comprises:
an aroma-active component that comprises one or more volatile compounds that attract the non-carnivorous mammal, wherein each volatile compound is capable of being produced by yeast subjected to anaerobic fermentation; and
a coating component for securing the composition to the feed particles and facilitating a controlled release of the one or more volatile compounds from the composition, upon the composition being mixed with the particulate feed.

2. The attractant and/or palatant composition of claim 1, wherein the aroma-active component further comprises a dried yeast, active and/or inactivated, that contain(s) all or a portion of the one or more volatile compounds.

3. The attractant and/or palatant composition of claim 2, wherein the aroma-active component is an active dried yeast and the effective amount of the attractant and/or palatant composition is such that, when applied to the particulate feed, the active dried yeast is at an amount in a range of about 0.1% to about 3% by weight of the particulate feed.

4. The attractant and/or palatant composition of claim 2, wherein the yeast is selected from the group consisting of Saccharomyces cerevisiae, Saccharomyces pastorianus, Saccharomyces bayanus, Saccharomyces chevalieri, Saccharomyces paradoxus, Saccharomyces eubayanus, Saccharomyces florentinus, Saccharomyces kudriavzevii, Saccharomyces boulardi, Saccharomyces var diastaticus, Picha fermentans, and combinations thereof.

5. The attractant and/or palatant composition of claim 2, wherein the aroma-active component further comprises a lysing agent at a concentration sufficient to cause lysis in at least a portion of any active yeast present in the aroma-active component.

6. The attractant and/or palatant composition of claim 2, wherein the yeast was grown on sugar/starch source selected from the group consisting of corn, sugar cane, wheat, rice, barley, sugar beets, citrus peel, and combinations thereof.

7. The attractant and/or palatant composition of claim 1, wherein each volatile compound is an ester that that is selected from the group consisting of acetate ester and ethyl ester.

8. The attractant and/or palatant composition of claim 7, wherein:
the acetate ester is selected from the group consisting of ethyl acetate, isoamyl acetate, and 2-phenyl acetate; and
the ethyl ester is selected from the group consisting of C₂-C₁₄ esters.

9. The attractant and/or palatant composition of claim 8, wherein the ethyl ester is selected from the group consisting of ethyl hexanoate, ethyl octanoate, and ethyl decanoate.

10. The attractant and/or palatant composition of claim 1, wherein the effective amount of the attractant and/or palatant composition is such that, when applied to the particulate feed, each volatile compound is at an amount in a range of about 0.1 ppm to about 6 ppm by weight of the particulate feed.

11. The attractant and/or palatant composition of claim 1, wherein the coating component is selected from the group consisting of a fat, C₆-C₂₁ fatty acid, polysorbate, ethoxylated castor oil, and combinations thereof.

12. The attractant and/or palatant composition of claim 1, wherein the effective amount of the attractant and/or palatant composition is such that, when applied to the particulate feed, the coating component is at an amount in a range of about 0.1% to about 3% by weight of the particulate feed.

13. The attractant and/or palatant composition of claim 1, wherein the one or more non-carnivorous mammals is selected from the group consisting of deer, raccoon, swine, and combinations thereof.

14. The attractant and/or palatant composition of claim 1, wherein the particulate feed comprises a cereal grain, oilseed, pelleted feed, or combinations of the thereof.

15. The attractant and/or palatant composition of claim 14, wherein:
the cereal grain is selected from the group consisting of corn, sorghum, barley, oats, rye, millet, wheat, rice, and combinations thereof; and
the oilseed is selected from the group consisting of soybean, rapeseed, canola, sunflower, peanut, and combinations thereof.

16. A method of preparing the attractant and/or palatant composition of claim 1, the method comprising mixing the aroma-active component and the coating component.

17. A method of treating a particulate feed for a non-carnivorous mammal, the method comprising contacting the particulate feed with an effective amount of the attractant and/or palatant composition of claim 1 such that particles of the particulate feed are at least partially coated with the attractant and/or palatant composition.

18. The method of claim 17, wherein the method improves the attractancy and/or palatancy of the treated particulate feed to the non-carnivorous mammal relative to: (a) an identical particulate feed without the attractant and/or palatant composition mixed therewith; and/or (b) an identical particulate feed mixed with an identical amount of the identical aroma-active component without the coating component.

19. A treated particulate feed for a non-carnivorous mammal, the treated particulate feed comprising an effective amount of the attractant and/or palatant composition of claim 1 at least partially coating particles of the particulate feed.

20. A method of attracting a non-carnivorous mammal to a location, the method comprising making available, dispensing, and/or dispersing the treated particulate feed for a non-carnivorous mammal of claim 19 at the location.

21. A method of increasing a number of visits of a type of non-carnivorous mammal to a location and/or the duration of such visits during a particular period, the method comprising making available, dispensing, and/or dispersing the treated particulate feed for a non-carnivorous mammal of claim 19 at the location, wherein said increase in number of visits and/or duration of such visits is relative to the number of visits and/or duration of visits by the type of non-carnivorous mammal to the same or comparable location over the same or comparable period while identically making available, dispensing, and/or dispersing an untreated particulate feed that is otherwise identical to the treated particulate feed but without the attractant and/or palatant composition.
